(19) United States
(12) Patent Application Publication
(10) Pub. No.: US 2014/0162612 A1
(43) Pub. Date: Jun. 12, 2014

(54) METHOD OF RECORDING CALL LOGS AND DEVICE THEREOF

(71) Applicant: Samsung Electronics Co., Ltd, Gyeonggi-do (KR)

(72) Inventor: Min Ma, Beijing (CN)

(73) Assignee: Samsung Electronics Co., Ltd, Gyeonggi-do (KR)

(21) Appl. No.: 14/102,318

(22) Filed: Dec. 10, 2013

(30) Foreign Application Priority Data
Dec. 10, 2012 (CN) 201210530424.X

(51) Int. Cl. H04W 4/16; G10L 19/00

(52) U.S. Cl. CPC H04W 4/16; G10L 19/00
USPC 455/414.1

(57) ABSTRACT

A method of recording a call comprises the following: when a terminal device is in a call status, performing an emotional recognition on the call to determine an emotion or a set of emotions related to the call; the terminal device giving emotional expression information to a corresponding image based on the emotion or the set of emotions related to the call; and the terminal device recording the call with the emotional expression information. The embodiments of the present disclosure further provide a terminal device of recording call logs. The solutions provided by the present disclosure may record call log by using an image, image series, or an animation, and thus it may not only ensure the privacy of communication information but also may increase the interest of use.

### PRIORITY

The present application is related to and claims priority under 35 U.S.C. §119(a) to a Chinese patent application filed in the State Intellectual Property Office of China on Dec. 10, 2012 and assigned Serial No. 201 210530424.X, the entire content of which is incorporated herein by reference.

### TECHNICAL FIELD

The present disclosure relates to the technical field of terminal devices, in an embodiment, the present disclosure relates to a method of recording call logs and device thereof.

### BACKGROUND

With the explosive increase of mobile users and varieties of mobile terminals, people's demands for voice applications are continuously developing. Generally, the sizes of the keyboard and screen of terminal devices are relatively small, it is not convenient for finger input, and especially in mobile application scenarios, users' eyes and hands are easy to get busy. Therefore, voice input becomes the most natural and convenient means of information interactions and its congenital superiority may be better made use of. Users may issue instructions through voice and corresponding operations are executed through voice recognition instead of through traditional key-pressing or touch operations, thus it is more convenient for the users to use.

With the development of voice technology, voiceprint recognition is gradually applied in people's life and is mainly embodied in the function of phone unlocking. For example, Xiamen Tiancong knowledge-software Co., Ltd. develops a “SIVI voiceprint lock” which may protect private application programs from being mindlessly surfing. When it is used for the first time, a voiceprint model may be registered to determine the voice of a legitimate user, and when it is used later, it may determine whether a current user is the legitimate user, and the legitimate user may normally use the selected functions. As another example, Superlock is a screen-locking and security-protecting program under the Android platform, and after the program service is started, the protecting function may be enabled when it powers on, screen is closed and protected programs are initiated, and unlock may be performed by using password, handshaking, voiceprint, etc. However, in above illustrations, the voiceprint recognition application may be limited to cell phone unlocking, the function thereof is monotonous and lacks of interest. Currently, the voiceprint recognition application may be used in terminal devices in isolation and lacks of integration with other techniques.

Therefore, it is necessary to propose an efficient technical solution to integrate the voiceprint technique with other techniques to apply them in the terminal technical field.

### SUMMARY

To address the above-discussed deficiencies, it is a primary object of the present disclosure to at least solve one of the above defects, especially by combining techniques of voiceprint recognition, emotional recognition and image processing, such that when the terminal device records call log, it not only may ensure the privacy of communication information but also may increase the interest of operability.

To achieve the above object, an aspect of the embodiments of the present disclosure proposes a method of recording call logs. The method includes that when a terminal device is in a call status, performing an emotional recognition on the call to determine an emotion or a set of emotions related to the call. The terminal device may give emotional expression information to a corresponding image based on the emotion or set of emotions related to the call. The terminal device recording the call with the emotional expression information.

Another aspect of the embodiments of the present disclosure also proposes a terminal device, which comprises a communication module, an emotional recognition module, an image processing module, and storage. The communication module being configured to proceed with a call with another user. The emotion recognizing module being configured to perform an emotional recognition on the call to determine an emotion or a set of emotions related to the call. The image processing module being configured to give emotional expression information to a corresponding image based on the emotion or the set of emotions related to the call. The storage module being configured to record the call with the emotional expression information.

The above method or terminal device of recording call logs disclosed by the present disclosure may adopt a voiceprint recognition function, emotional recognition function and image processing function of a character with the emotional expression information without additional hardware. The terminal device records the call log by using the combination techniques of voiceprint recognition, emotional recognition and image processing, such that it may not only ensure the privacy of communication information but also may increase the interest of operability and includes a strong utility.

The additional aspects and advantages of the present disclosure will be introduced in the following description, and these will be apparent from the following description, or will be known from the practice of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process of a method of recording call logs according to an embodiment of the present disclosure;

FIG. 2 illustrates a functional schematic diagram of applying the present disclosure;

FIG. 3 illustrates a schematic diagram of adding audio information;

FIG. 4 illustrates a schematic diagram of the way of selecting adding audio;

FIG. 5 illustrates a schematic diagram of starting voiceprint recognition;

FIG. 6 illustrates a schematic diagram of storing a corresponding image to a phonebook;

FIG. 7 illustrates a schematic diagram where an image of a talking person at a peer side of the terminal device is in the phonebook;

FIG. 8 illustrates a schematic diagram of recognizing results for two calls with different emotions;

FIG. 9 illustrates a schematic diagram of recording call logs in a first application scenario;

FIG. 10 illustrates a schematic diagram of an image set by a user at a local side of the terminal device;

FIG. 11 illustrates a schematic diagram of a combined image representing the emotion of the call;

FIG. 12 illustrates a schematic diagram of call logs containing images with the emotional expression information;

FIG. 13 illustrates a schematic diagram where the image of a talking person at a peer side of the terminal device is not existed in the phonebook;

FIG. 14 illustrates a schematic diagram of recording call logs in a second application scenario;

FIG. 15 illustrates a schematic diagram of storing the corresponding image in the phonebook of the terminal device; and

FIG. 16 illustrates a structural schematic diagram of the terminal device of an embodiment of the present disclosure.

### DETAILED DESCRIPTION

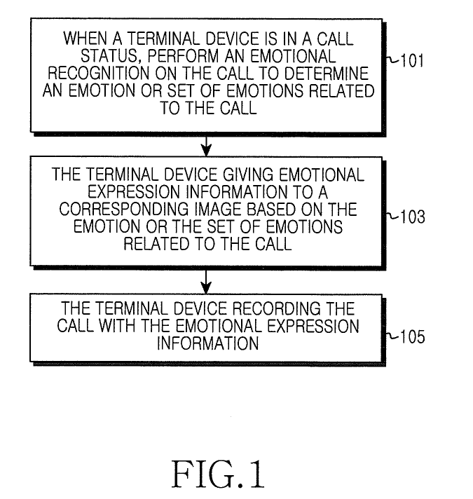

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Embodiments of the present disclosure will be described in detail hereafter. The examples of the embodiments will be illustrated by the accompanying drawings, wherein similar or same numeral symbols indicate similar or same elements or elements with same or similar functions. The embodiments described with reference to the drawings are intended to explain the present disclosure and should not be construed as limitation to the present disclosure.

It will be understood by the skilled in the art that the singular forms “a”, “an”, “the”, and “said” may be intended to include plural forms as well, unless the context clearly indicates otherwise. It should be further understood that the terms “comprises/comprising” used in this specification specify the presence of stated features, integers, blocks, operations, elements, and/or components, but do not preclude the presence or addition of one or more other features, integers, blocks, operations, elements, components, and/or groups thereof. It should be understood that when a component is referred to as being “connected to” or “coupled to” another component, it may be directly connected or coupled to the other element or intervening elements may be present. In addition, the “connected to” or “coupled to” may also refer to wireless connection or couple. As used herein, the term “and/or” includes any and all combinations of one or more of the associated listed items.

Unless otherwise defined, all terms (including technical and scientific terms) used herein include the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Those skilled in the art will understand that the term “terminal” used herein compasses not only devices with a wireless signal receiver that includes no emission capability but also devices with receiving and emitting hardware capable of carrying out bidirectional communication over the two-way communication link. This kind of devices may include a cellular or other communication device with or without a multi-line display; a personal communication system (PCS) with combined functionalities of voice and data processing, facsimile and/or data communication capability; may include a PDA that includes a RF receiver and an network/intranet access, web browser, notepad, calendar and/or global positioning system (GPS) receiver; and/or a conventional laptop and/or palm computer or other devices that includes a RF receiver. The “mobile terminal” used herein may refer to portable, transportable, fixed on a transportation (aviation, maritime and/or terrestrial) or suitable for and/or configured to run locally and/or run in the form of distribution on the earth and/or other places in the spaces. The “mobile terminal” used herein may also refer to a communication terminal, Network terminal, music/video player terminal. The “mobile terminal” used herein may also refer to PDA, MID, and/or mobile phone with music/video playback capabilities etc.

To achieve the object of the present disclosure, the embodiments of the present disclosure propose a method of recording call logs, comprising the following:

when a terminal device is in a call status, performing an emotional recognition on the call to determine an emotion or a set of emotions related to the call;

the terminal device giving emotional expression information to a corresponding image based on the emotion or the set of emotions related to the call; and the terminal device recording the call with the emotional expression information.

FIG. 1 illustrates a process of the method of recoding call logs according to an embodiment of the present disclosure, comprising blocks S110 to S130.

In block 101, when the terminal device is in a call status, the process performs an emotional recognition on the call to determine an emotion or a set of emotions related to the call.

In a detailed application, the method may further comprise: selecting an image corresponding to the call, and the corresponding image comprises but is not limited to: a preset image, a selected image or an image determined by using voiceprint information. For example, the preset image may be a simple icon that may express a certain emotion.

For example, before or simultaneously with execution of block 101, it may further comprise: the terminal device obtaining audio information. The way by which the terminal device obtains the audio information comprises but is not limited to the following ways:

the terminal device obtains the audio information during a call; or the terminal device obtains the audio information according to an audio file. The terminal device obtaining the audio files comprises but is not limited to the following ways: the terminal device obtains audio files from the audio files uploaded by the user; or the terminal device records the user's voice into an audio file in advance. In the above, the audio files comprise but are not limited to the following formats: CD, WAV, AU, MP3, MIDI, WMA, RealAudio, VQF, OggVorbis, AAC, and APE.

In block 101, when the terminal device is in a call status and a character whose voiceprint is the most similar to that of the obtained audio information is determined by using voiceprint recognition, and an image that includes the most similar character is selected as the corresponding image.

For example, the terminal device extracts basic features reflecting information of an individual from the audio information by using the voiceprint recognition technique. These basic features may distinguish different vocal individuals exactly and efficiently. With respect to an identical individual, these basic features may be stable. Then, with a corresponding mode matching method, a matched voiceprint sample which is most similar to the audio information may be obtained by that is compared with voiceprint samples in a local voiceprint database or in a network voiceprint database. Then, an image which includes a character matched by the voiceprint sample may be obtained, wherein the image may also come from the local terminal or network and a one to one correspondence may exist between the image and the voiceprint sample. Generally, the character corresponding to the audio information may be a star or a cartoon character well known by most people.

The image of the most similar character comprises but is not limited to the following formats: bmp, jpg, tiff, gif, pcx, tga, exif, fpx, svg, psd, cdr, pcd, dxf, ufo, eps, ai, or raw.

At block 103, the terminal device may give emotional expression information to the corresponding image based on the emotion or the set of emotions related to the call.

In the block 103, the emotion or the set of emotions related to the call comprises any of the following examples: an emotion or a set of emotions of a user at a local side of the terminal device during the call, a talking person at a peer side of the terminal device during the call or users at both sides during the call.

Thereafter, the corresponding image may be collected to generate an image, image series, or an animation that embodies the emotion or the set of the emotions.

For example, if selecting to record the emotions of the users at both sides during the call, emotion changes of the users at both sides during a call may be recorded respectively. For example, the emotion changes of the users at both sides are recorded by taking thirty seconds as a time scale. Finally, the main emotion of the individual user at each side during the call may be obtained, which may further be used to get a set of emotions, and the images of the users at both sides during the call are given with emotional expression information, such that the image that includes the set of emotions may be obtained. In addition, the corresponding images may also be collected to generate an image set that includes a set of emotions. For example, an image set that takes 30 seconds as the time scale to record the emotion changes of the users at both sides may be obtained.

Further, the corresponding image may also be collected to generate an animation that includes a set of emotions. For example, an animation that takes thirty seconds as the time scale to record the emotion changes of the users at both sides may be obtained.

To be specific, the above emotion may comprise: happiness, anger, sadness, joy, mourning, fear or scare, and any one that may express emotions related to the call may be included.

For example, a facial image may be processed to include a corresponding emotion by using the image processing technique. With respect to the image processing technique, firstly the technique detects and positions organs on the face, and then processes the facial image according to the features of the organs related to a corresponding emotion, thus a facial image that includes the corresponding emotion may be obtained.

At block 105, the terminal device records the call with the emotional expression information.

In the block 105, the terminal device recording the call with the emotional expression information comprises the following one kind or more kinds of information:

an image, image series or an animation that embodies the emotion or the set of emotions, a telephone number of an incoming call, a caller's name of an incoming call, a starting moment of the call, an ending moment of the call, a call duration, and other information related to the call log.

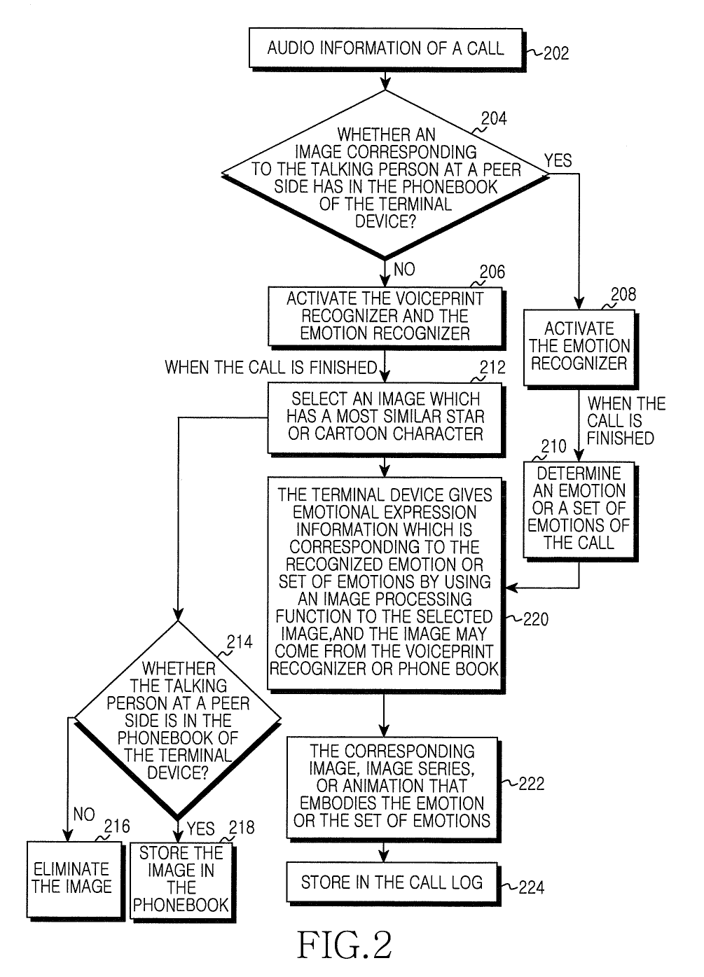

To further illustrate the present disclosure, description will be made combined with detailed applications. FIG. 2 illustrates a functional schematic diagram of applying the present disclosure.

When a call is started, audio information of a call is received at block 202, the terminal device may firstly judge whether an image corresponding to the talking person at a peer side includes in the phonebook of the terminal device at block 204. If there is “no”, at block 206 a voiceprint recognizer and an emotion recognizer are activated simultaneously; and if there is a “yes”, at block 208 the emotion recognizer may be activated. At block 210, the process may determine an emotion or a set of emotions of the call. At block 212, the process may select an image which has a most similar star or cartoon character. At block 214, the terminal device may determine whether the talking person at a peer side is in the phonebook of the terminal device. If “no”, at block 216, the process eliminates the image. If “yes”, at block 218, the process stores the image in the phonebook. At block 220, the terminal device gives emotional expression information which is corresponding to the recognized emotion or set of emotions by using an image processing function to the selected image, and the image may come from the voiceprint recognizer or phone book. At block 222, the process retrieves the corresponding image, image series, or animation that embodies the emotion or the set of emotions. At block 224, the process stores the corresponding image, image series, or animation.

The voiceprint recognizer recognizes the voiceprint of the talking person at a peer side, and the emotion recognizer may recognize the emotions of the user at a local side, the talking person at a peer side of the call or the users at both sides during the call. For example, at the circumstance that no corresponding image of the user at each side or both sides is recorded in the phonebook, when the call is finished, the voiceprint recognizer may select an image which includes a most similar star or cartoon character according to a voiceprint maximum similarity principle as the corresponding image for representing the user at each side or both sides, at block 212. Then, the emotion recognizer determines an emotion or a set of emotions of the call; then the terminal device gives emotional expression information which is corresponding to the recognized emotion or set of emotions by using an image processing function to the selected image at block 210. Finally, what stored in the call log is the corresponding image, image series, or animation that embodies the emotion or the set of emotions at block 224. From above all, a dynamic call log may be obtained.

Further, at block 214, if the talking person at a peer side is in the phonebook of the terminal device, a corresponding image matching the voiceprint recognition is stored in the phonebook of the terminal device at block 216; and if the talking person at a peer side is not in the phonebook at block 214, a corresponding image matching the voiceprint recognition is not required to be stored in the phonebook of the terminal device at block 218, and the terminal device stores the image, image series, or the animation that embodies the emotion or the set of emotions in the call log.

Obviously, when the talking person at a peer side is not in the phonebook, the user may also add the talking person to the phonebook and store a corresponding image selected by the voiceprint recognition related to the talking person.

Referring to first application scenario of the present disclosure, the terminal device obtains audio information and determines a corresponding image of a contacting person.

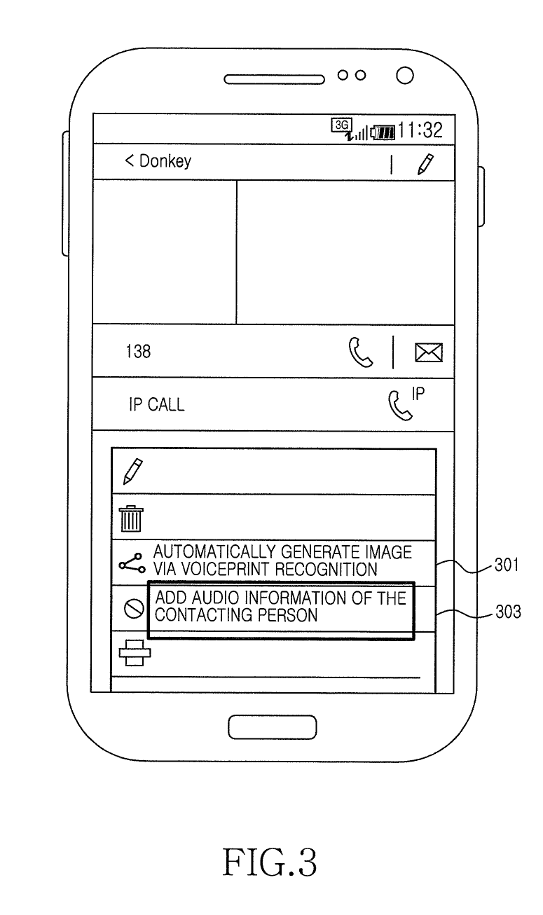

FIG. 3 illustrates a schematic diagram of adding audio information. As shown in FIG. 3, the voiceprint recognizer is activated by using a menu “automatically generate image via voiceprint recognition” 301 to analyze the audio information. When a certain name card in the phonebook of the terminal device is selected, audio information of the contacting person may be added by using a menu “add audio information of the contacting person” 303.

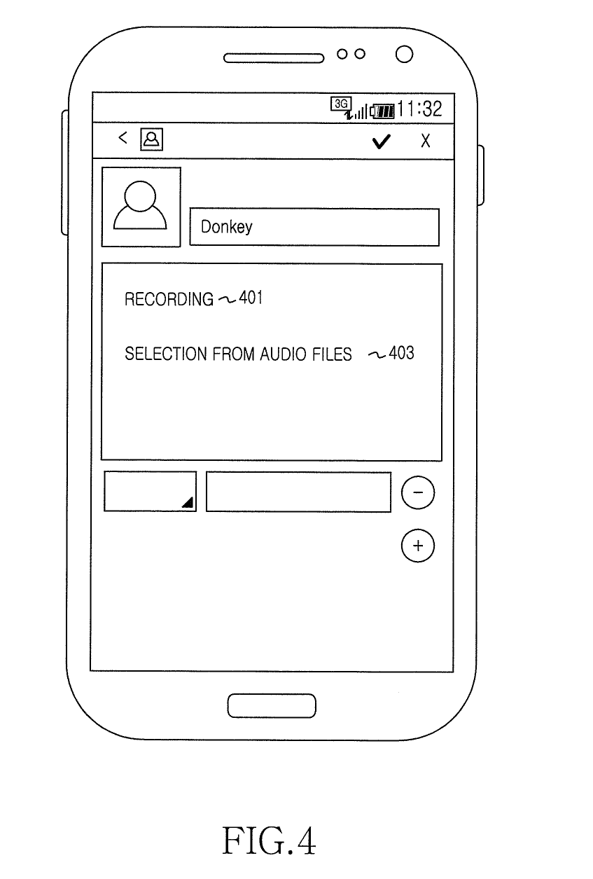

FIG. 4 illustrates a schematic diagram of the way of selecting adding audio. As shown in FIG. 4, the audio information may either be obtained from audio files 403 or be obtained by recording 401 on the spot via the terminal device operated by the user.

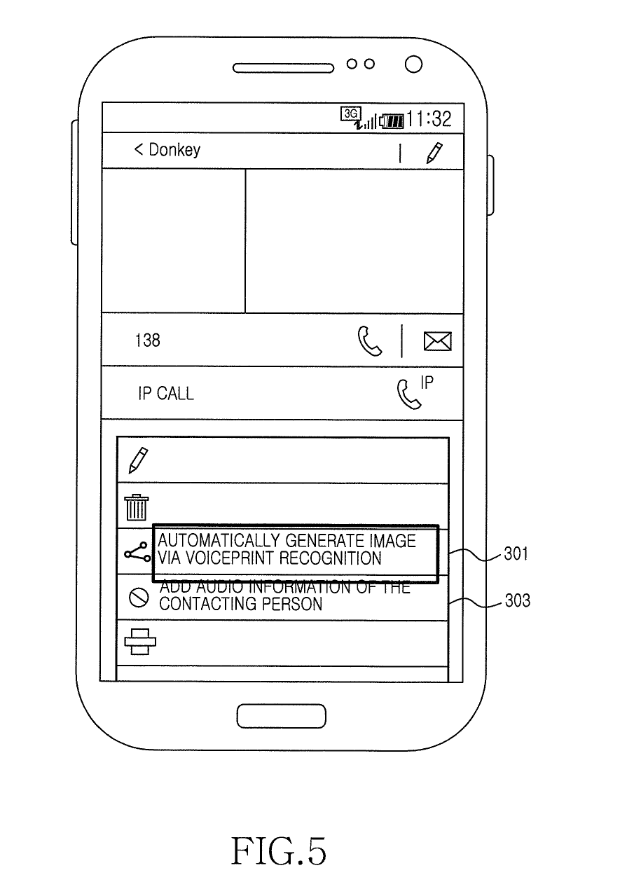

FIG. 5 illustrates a schematic diagram of starting voiceprint recognition. Then, as shown in FIG. 5, the voiceprint recognizer is activated by using a menu “automatically generate image via voiceprint recognition” 303 to analyze the audio information.

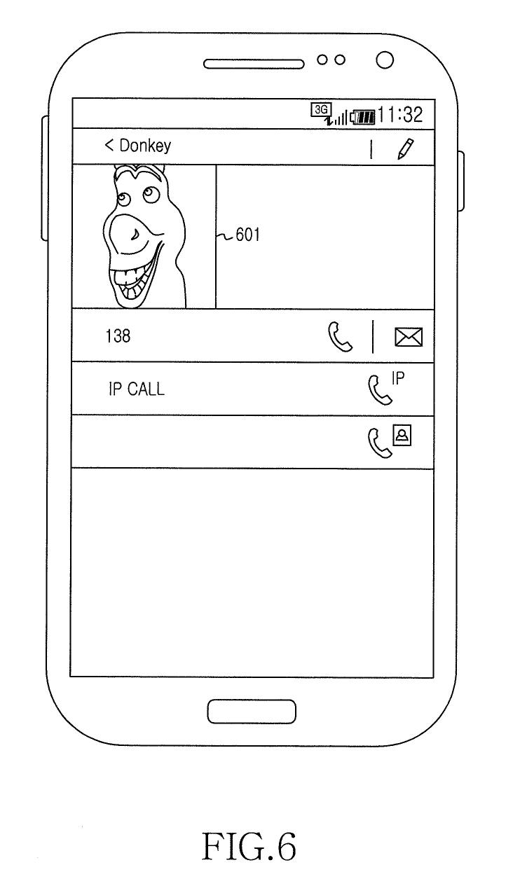

FIG. 6 illustrates a schematic diagram of storing a corresponding image to a phonebook. Then, as shown in FIG. 6, an image 601 which includes a most similar star or cartoon character according to a principle of matching a voiceprint with a maximum similarity is obtained and stored in the phonebook of the terminal device.

Referring to second application scenario of the present disclosure, the user of the terminal device communicates with a contacting person who is represented by a corresponding image recorded in the phonebook of the terminal device.

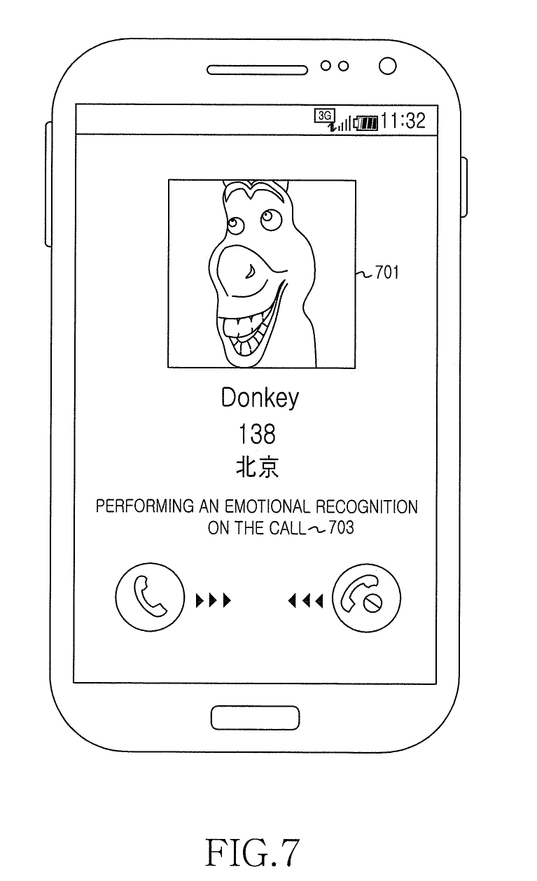

FIG. 7 illustrates a schematic diagram showing where the image of a talking person at a peer side of the terminal device is contained in the phonebook. As shown in FIG. 7, when a call is started, the terminal device activates the emotion recognizer. The emotion recognizer may select to perform emotional recognition 703 on the talking person at a peer side of the call during the call. Obviously, the emotion recognizer may also select to perform emotional recognition on the user at a local side of the terminal device. When the call is finished, an emotion or a set of emotions of the call may be determined. Then, a corresponding image 701 recorded in the phonebook of the terminal device may be given emotional expression information according to the recognized emotion or set of emotions. Then, the terminal device records the corresponding image, image series, or an animation that embodies the emotion or the set of emotions in the call log to generate a dynamic call log.

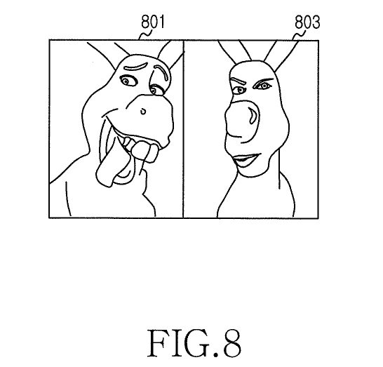

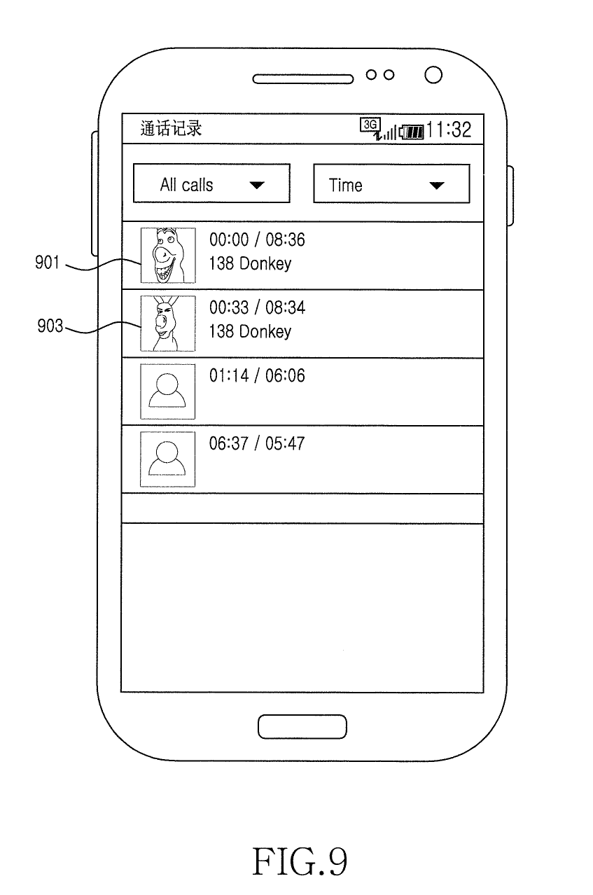

FIG. 8 illustrates a schematic diagram of recognizing results for two calls with different emotions 801 and 803. FIG. 9 illustrates a schematic diagram of recording call logs in a first application scenario, In other words, as shown in FIG. 8 and FIG. 9, though the user of the terminal device communicates with an identical contacting person in the phonebook of the terminal device, the stored image, image series or an animation of the call log may be different if the emotions 901 and 903 related to different calls are different.

Referring to third application scenario of the present disclosure, the user of the terminal device communicates with a contacting person who is represented by a corresponding image recorded in the phonebook of the terminal device.

As shown in FIG. 7, when a call is started, the terminal device activates the emotion recognizer. The emotion recognizer may perform emotional recognition on the users at both sides during the call.

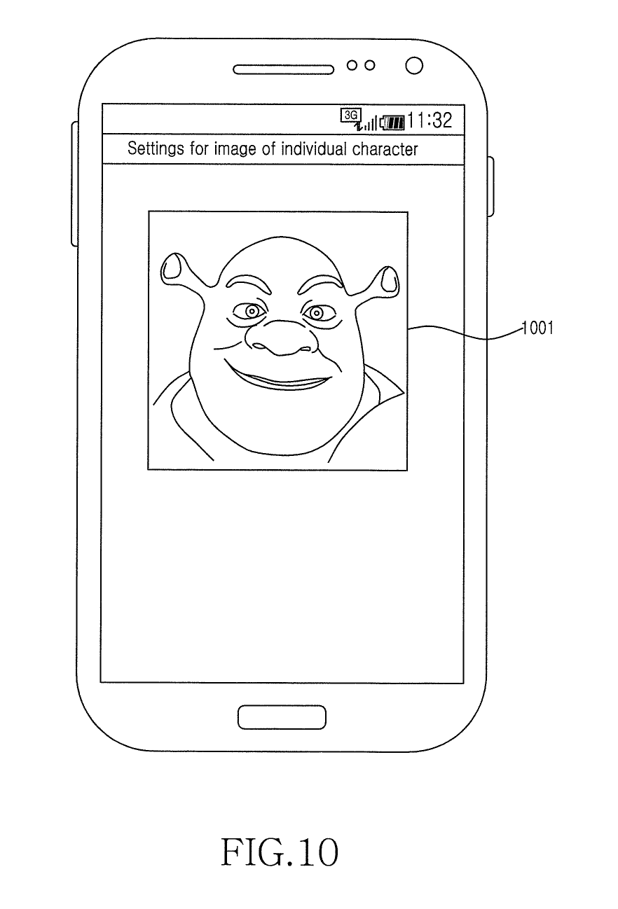

FIG. 10 illustrates a schematic diagram of an image set by a user at a local side of the terminal device. As shown in FIG. 10, when the call is finished, a set of emotions of the users at both sides during the call may be determined. Then, a corresponding image recorded in the phonebook of the terminal device and an image preset by the user at a local side in the terminal device may be given emotional expression information by taking advantage of the recognized emotion or set of emotions, where the image 1001 preset by the use at a local side may be configured by taking photos or introducing from a storage medium, etc.

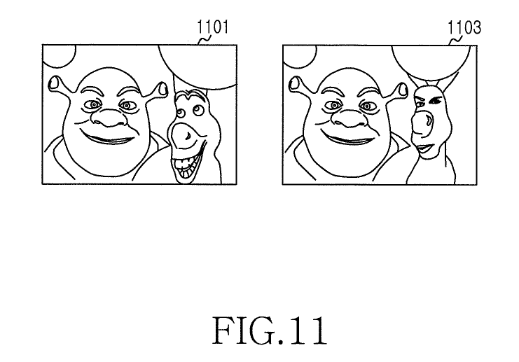

FIG. 11 illustrates a schematic diagram of a combined image representing the emotion of the call. Finally, as shown in FIG. 11, an image, image series or an animation representing the set of emotions 1101 and 1103 of the call is generated.

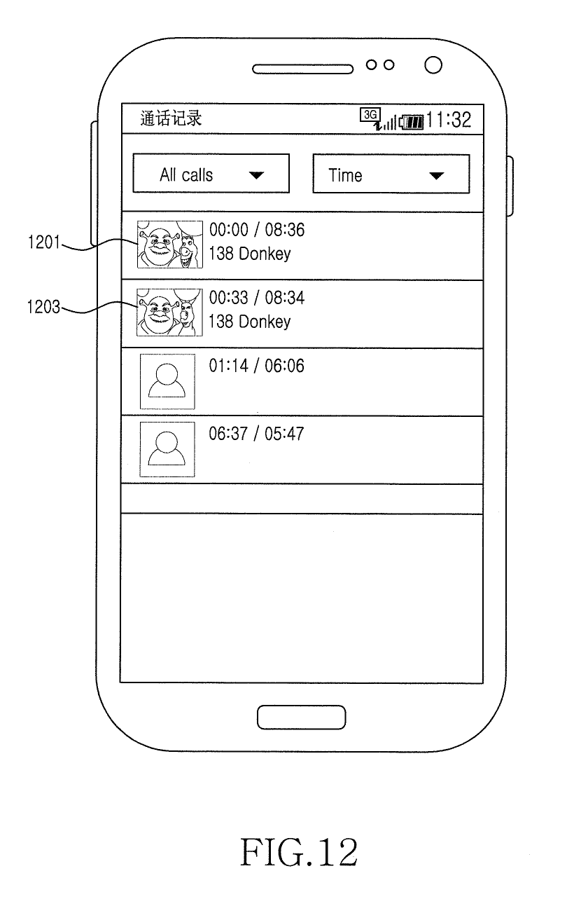

FIG. 12 illustrates a schematic diagram of call logs containing images 1201 and 1203 with the emotional expression information. As shown in FIG. 12, the terminal device records the image, image series or an animation in the call log. Thus, a dynamic call log may be obtained.

Referring to fourth application scenario of the present disclosure, the user of the terminal device communicates with a contacting person who has not been represented by a corresponding image recorded in the phonebook of the terminal device.

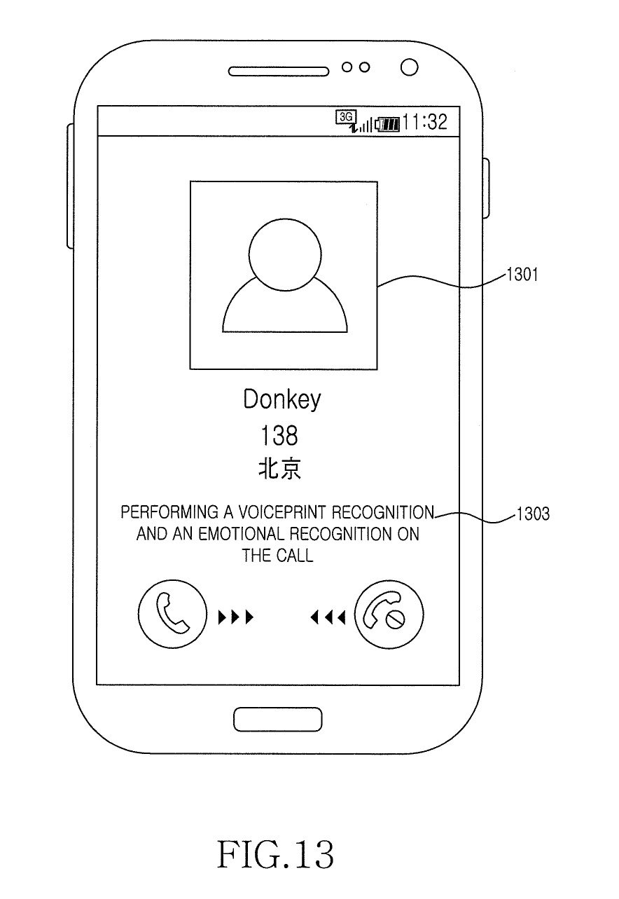

FIG. 13 illustrates a schematic diagram where the image 1301 of a talking person at a peer side of the terminal device is not contained in the phonebook. As shown in FIG. 13, when the call starts, the terminal device activates the voiceprint recognizer and the emotion recognizer 1303. The voiceprint recognizer recognizes the voiceprint of the talking person at a peer side, and the emotion recognizer recognizes the emotions of the user at a local side, the talking person at a peer side or the users at both sides during the call.

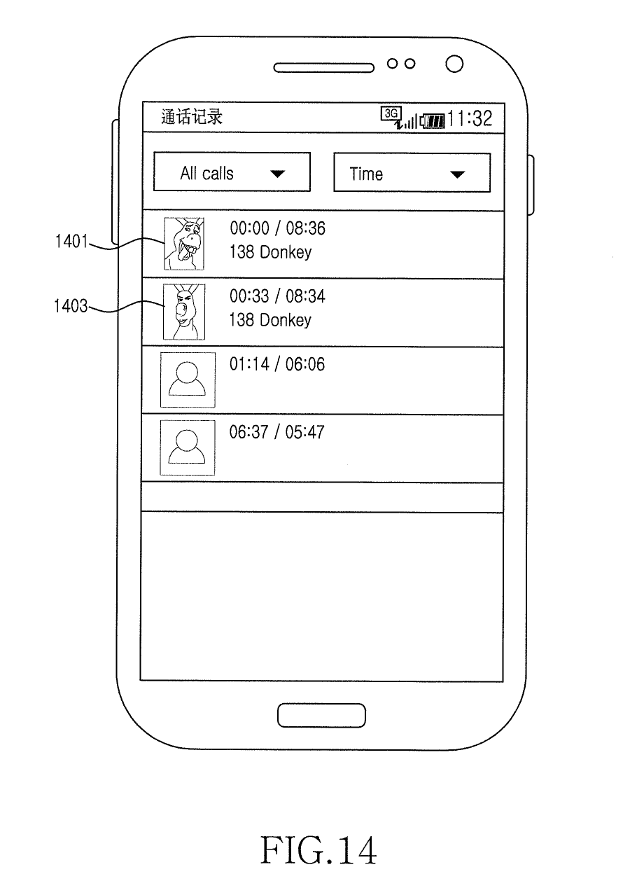

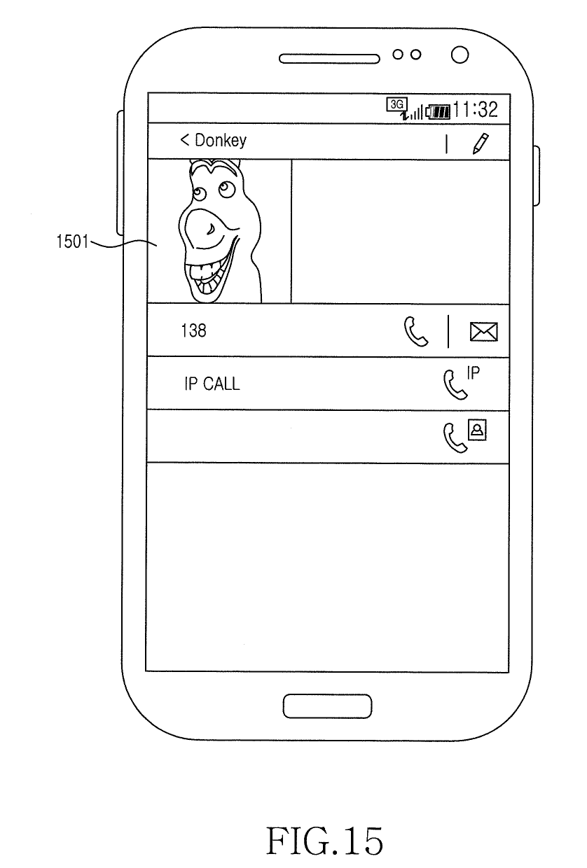

FIG. 14 illustrates a schematic diagram of recording call logs in a second application scenario. As shown in FIG. 14, when the call is finished, the voiceprint recognizer may select an image which includes a most similar star or cartoon character according to a voiceprint maximum similarity principle as the corresponding image. Then, the emotion recognizer determines an emotion or a set of emotions of the call; then the terminal device gives emotional expression information which is corresponding to the recognized emotion or set of emotions by using an image processing function to the selected image. Then, the terminal device records the corresponding images 1401 and 1403, image series, or animation that embodies the emotion or the set of emotions in the call log to generate a dynamic call log. If the talking person at a peer side has been recorded in the phonebook of the terminal device, the corresponding image is stored in the phonebook of the terminal device together, as shown in FIG. 15; and if the talking person at a peer side has not been recorded in the phonebook of the terminal device, the corresponding image is eliminated. FIG. 15 illustrates a schematic diagram of storing the corresponding image 1501 in the phonebook of the terminal device.

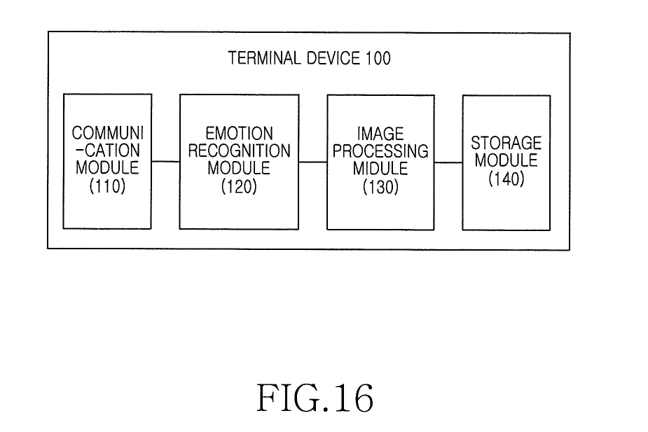

FIG. 16 illustrates a structural schematic diagram of the terminal device of an embodiment of the present disclosure. As shown in FIG. 16, according to another aspect of the present, one embodiment further proposes a terminal device 100, which comprises: a communication module 110, an emotional recognition module 120, an image processing module 130 and a storage module 140, in which:

the communication module 110 is configured to proceed a call to communicate with a contacting person;

the emotional recognition module 120 is configured to perform an emotional recognition on the call to determine an emotion or a set of emotions related to the call;

the image processing module 130 is configured to give emotional expression information to a corresponding image based on the emotion or the set of emotions related to the call; and the storage module 140 is configured to record the call with the emotional expression information.

In an embodiment, the image processing module 130 is further configured to select an image corresponding to the call, and the corresponding image comprises but is not limited to: a preset image, a selected image or an image determined by using voiceprint information.

In the above, the terminal device 100 may further comprise: a voiceprint recognition module (not shown), in which:

the communication module 110 is further configured to obtain audio information, and the voiceprint recognition module is configured to determine a character whose voiceprint is the most similar to that of the obtained audio information by using voiceprint recognition, and the image processing module 130 selects an image which includes the most similar character as a corresponding image.

In an embodiment, the communication module 110 is configured to obtain audio information comprises:

the communication module 110 is configured to obtain audio information during the call; or

the communication module 110 is configured to obtain audio information according to an audio file.

In an embodiment, the emotional recognition module 120 being configured to perform emotional recognition on the call to determine an emotion or a set of emotions related to the call comprises any of the following ways:

the emotional recognition module 120 is configured to perform emotional recognition on the call to determine the emotion or the set of emotions of a user at a local side of the terminal device during the call;

the emotional recognition module 120 is configured to perform emotional recognition on the call to determine an emotion or a set of emotions of a talking person at a peer side of the terminal device during the call;

the emotional recognition module 120 is configured to perform emotional recognition on the call to determine an emotion or a set of emotions of users at both sides during the call.

In an embodiment, the image processing module 130 being configured to give emotional expression information to the corresponding image comprises:

the image processing module 130 is configured to convert the corresponding image into an image, image series, or an animation that embodies the emotion or the set of emotions based on the emotion or set of emotions related to the call.

In an embodiment, the emotion given emotional expression information by the image processing module 130 may comprise: happiness, anger, sadness, joy, mourning, fear or scare, and any one that may express emotions related to the call may be included.

In an embodiment, the storage module 140 being configured to record the call with the emotional expression information comprises recording the following one kind or more kinds of information:

an image, image series or an animation that embodies the emotion or the set of emotions, a telephone number of an incoming call, a caller's name of an incoming call, a starting moment of the call, an ending moment of the call or a call duration, and other information related to the call log.

The method and terminal device of recording call logs disclosed by the present disclosure include one or multiple of the following advantages:

adopts a voiceprint recognition function, emotional recognition function and image processing function of a character with the emotional expression information without additional hardware, and it includes a wide range of adaptability;

the terminal device is not required to upload the audio information to the network to process, such that the privacy of the user's audio information may be ensured;

the terminal device may recognize emotions such as happiness, anger, sadness, joy, mourning, fear, scare, etc. embodied in the audio by an audio recognition during the call, and record an image recording the emotion or the set of emotions in the call log; and

the user may also manually add audio files, the terminal device determines an image of a star or an animation similar to the audio information, and record it in the terminal device, which increases the interest of operability.

It may be understood by those skilled in the art that the present disclosure may relate to a device executing one or several of the operations in the present disclosure. The device may be designed and manufactured for intended purpose, or comprises known devices in a general computer, the general computer being activated or reconstructed selectively by programs stored therein. These computer programs may be stored on device (e.g. computer) readable storage medium or stored in any type of media that are suitable for storing electronic instructions and are coupled to the bus, the computer readable media including, but not limited to any type of disk (including floppy disk, hard disk, CD, CD-ROM and magnet disk), RAM, ROM, EPROM, EPROM, EEPROM, flash, magnet card, or light card. The readable media comprise any mechanism that stores or transmits information by way of being device (computer) readable. For example, a computer-readable medium includes RAM, ROM, magnet storage medium, optical storage medium, flash, signals transmitted by electricity, optical storage media, flash, and transmitting signals in the form of electricity, light, sound or others (e.g. carrier wave, infrared signal, digital signal), and the like.

It may be understood by those skilled in the art that the present disclosure has been described with reference to the structural diagrams and/or blocks and/or flowcharts of methods, systems, and computer programming products of the implementation of the present disclosure. It should be understood that each block in the structural diagrams and/or blocks and/or flowcharts or blocks combinations in these structural diagrams and/or blocks and/or flowcharts or blocks may be implemented by using computer programming instructions. These computer programming instructions may be provided to a general purpose computer, a specialized computer or other processors of programmable data processing methods to generate the machine, such that the instructions executed by a computer or processors of other programmable data processing methods to create the methods indicated by the boxes in the structural diagrams and/or block diagrams and/or flowcharts.

It may be understood by those skilled in the art that these computer programming instructions may also be loaded into a computer or other programmable data processing methods to make a sequence of operation blocks may be executed on the computer or other programmable data processing methods to generate processes that may be implemented by the computer; thus the instructions executed on the computer or other programmable data processing methods provide blocks for implementing blocks indicated in the box or boxes in the structural diagrams and/or block diagrams and/or flowcharts.

It may be understood by those skilled in the art that the blocks, measures, schemes in the various operations, methods and flowcharts that have been discussed may be alternated, changed, combined or deleted. Furthermore, other blocks, measures, schemes that include the various operations, methods and flowcharts that have been discussed may also be alternated, changed, rearranged, decomposed, combined or deleted. Furthermore, the blocks, measures, and schemes in the traditional art or in the present disclosure may be alternated, changed, rearranged, decomposed, combined or deleted.

The example implementations are disclosed in the accompanying drawings and the specification. Though certain terminologies are used herein for general and description usage purpose, and should not be constructed as limiting. It should be pointed out that for those ordinary skilled in the art, various modifications and improvements may be made without departing from the principle of the disclosure, and those modifications and improvements should be deemed according to the scope of the present disclosure. The protecting scope of the present disclosure should be defined by the claims of the present disclosure.

Although the disclosure has been shown and described with reference to certain embodiments thereof, it will be understood by those skilled in the art that various changes in form and details may be made therein without departing from the spirit and scope of the disclosure as defined by the appended claims and their equivalents. Therefore, the scope of the present disclosure is not limited to the above-described embodiments but is defined by the appended claims and the equivalents thereof.

What is claimed is:

1. A method of recording call logs, comprising:
when a terminal device is in a call status, performing an emotional recognition on the call to determine an emotion or a set of emotions related to the call;
giving, by the terminal device, emotional expression information to a corresponding image based on the emotion or the set of emotions related to the call; and
recording, by the terminal device, the call with the emotional expression information.

2. The method of claim 1, wherein the corresponding image is selected from a group consisting of:
a preset image;
a selected image; and
an image of a most similar selected by that the terminal device obtains audio information and determines the character whose voiceprint is the most similar to that of the obtained audio information by using voiceprint recognition.

3. The method of claim 2, wherein the terminal device obtaining audio information comprises:
the terminal device obtaining the audio information during the call; and
the terminal device obtaining the audio information according to an audio file.

4. The method of claim 1, wherein the emotional recognition on the call to determine the emotion or the set of emotions related to the call comprises:
performing the emotional recognition on the call to determine an emotion or a set of emotions of a user at a local side of the terminal device during the call.

5. The method of claim 4, wherein giving emotional expression information to the corresponding image comprises:
converting the corresponding image into an image, image series or an animation that embodies the emotion or the set of emotions.

6. The method of claim 5, wherein the emotions comprise happiness, anger, sadness, joy, mourning, fear, and scare.

7. The method of claims 1, wherein the terminal device recording the call with the emotional expression information comprises information selected from a group consisting of:
an image, image series or an animation that embodies the emotion or the set of emotions,
a starting moment of the call,
an ending moment of the call,
a call duration,
a telephone number of an incoming call, and
a caller's name of an incoming call.

8. A terminal device, comprising a communication module, an emotional recognition module, an image processing module, and a storage module:
the communication module being configured to proceed a call to communicate with a contacting person;
the emotion recognizing module being configured to perform an emotional recognition on the call to determine an emotion or a set of emotions related to the call;
the image processing module being configured to give emotional expression information to a corresponding image based on the emotion or the set of emotions related to the call; and
the storage module being configured to record the call with the emotional expression information.

9. The terminal device according to claim 8, further comprising: a voiceprint recognition module:
the communication module being further configured to obtain audio information,
the voiceprint recognition module being configured to determine a character whose voiceprint is the most similar to that of the obtained audio information by using voiceprint recognition, and
the image processing module being configured to select an image of a most similar or select a preset image or a selected image.

10. The terminal device according to claim 9, wherein the communication module being configured to obtain audio information comprises:
the communication module being configured to obtain the audio information during the call; and
the communication module being configured to obtain the audio information according to an audio file.

11. The terminal device according to claim 8, wherein the emotional recognition module being configured to perform the emotional recognition on the call to determine the emotion or the set of emotions related to the call comprises:
the emotional recognition module being configured to perform the emotional recognition on the call to determine an emotion or a set of emotions of a user at a local side of the terminal device during the call.

12. The terminal device according to claim 11, wherein the image processing module being configured to give emotional expression information to the corresponding image comprises:
the image processing module being configured to convert the corresponding image into an image, image series, or an animation that embodies the emotion or the set of emotions based on the emotion or set of emotions related to the call.

13. The terminal device according to claim 12, wherein the emotion given emotional expression information by the image processing module comprises: happiness, anger, sadness, joy, mourning, fear, or scare.

14. The terminal device according to any of claims 8, wherein the storage module being configured to record the call with the emotional expression information comprises recording the following one kind or more kinds of information:
an image, an image set or an animation that embodies the emotion or the set of emotions,
a starting moment of the call,
an ending moment of the call,
a call duration,
a telephone number of an incoming call, and
a caller's name of an incoming call.

15. The method of claim 1, wherein the emotional recognition on the call to determine the emotion or the set of emotions related to the call comprises:
performing the emotional recognition on the call to determine an emotion or a set of emotions of a talking person at a peer side of the terminal device during the call.

16. The method of claim 1, wherein the emotional recognition on the call to determine the emotion or the set of emotions related to the call comprises:
performing the emotional recognition on the call to determine an emotion or a set of emotions of users at both sides during the call.

17. The terminal device according to claim 8, wherein the emotional recognition module being configured to perform the emotional recognition on the call to determine the emotion or the set of emotions related to the call comprises:
the emotional recognition module being configured to perform the emotional recognition on the call to determine an emotion or a set of emotions of a talking person at a peer side of the terminal device during the call; and

18. The terminal device according to claim 8, wherein the emotional recognition module being configured to perform the emotional recognition on the call to determine the emotion or the set of emotions related to the call comprises:
the emotional recognition module being configured to perform the emotional recognition on the call to determine an emotion or a set of emotions of users at both sides during the call

19. An apparatus comprising:
a memory element; and
a processor associated with the memory element, wherein the processor is configured to execute a set of instructions, the instructions comprising:
performing an emotional recognition on the call to determine an emotion or a set of emotions related to the call;
giving, by the terminal device, emotional expression information to a corresponding image based on the emotion or the set of emotions related to the call; and
recording, by the terminal device, the call with the emotional expression information.

20. The apparatus of claim 19, wherein the corresponding image is selected from a group consisting of:
a preset image;
a selected image; and
an image of a most similar selected by that the terminal device obtains audio information and determines the character whose voiceprint is the most similar to that of the obtained audio information by using voiceprint recognition.
